(19) United States
(12) Patent Application Publication
(10) Pub. No.: US 2026/0000572 A1
(43) Pub. Date: Jan. 1, 2026

(54) Sex Toy Apparatus

(71) Applicants: Gary Cummings, Sheffield (GB); Phil Thompson, Bristol (GB)

(72) Inventors: Gary Cummings, Sheffield (GB); Phil Thompson, Bristol (GB)

(21) Appl. No.: 18/755,753

(22) Filed: Jun. 27, 2024

(51) Int. Cl. A61H 19/00; A61H 23/02

(52) U.S. Cl. CPC A61H 19/44; A61H 23/0254; A61H 2201/0153; A61H 2205/087

(57) ABSTRACT

The present disclosure provides a sex toy apparatus that has a shaft portion with an exterior wall formed by a plurality of stacked disc elements, each disc element comprising a number of protrusions disposed about its circumference and being individually motorised by an internal motor assembly of the toy such that the movement of adjacent disc elements with respect to one another is controllable. The disc elements each rotate about the central axis, and the ability to individually rotate the protrusions on their circumferences at different rates and in different directions allows for unique stimulation patterns.

### FIELD OF INVENTION

The present invention relates generally to a novel sex toy design. More specifically, the present invention relates to a sex toy having individually motorized disc elements forming a shaft wall.

### BACKGROUND

The sex toy industry has experienced exponential growth in recent years, with a more open societal approach to sex and masturbation in general coinciding with a number of technological innovations in the field.

Despite these advances, however, the majority of motorised sex toys still use very simple stimulation mechanisms, with the control interfaces allowing a user only to switch between very basic vibration patterns and speed settings. Users of sex toys wish for novel and more varied stimulation patterns, and while some alternative solutions do exist, their complex designs often render them delicate and expensive.

It is within this context that the present invention is provided.

### SUMMARY

The present disclosure provides a sex toy apparatus that has a shaft portion with an exterior wall formed by a plurality of stacked disc elements, each disc element comprising a number of protrusions disposed about its circumference and being individually motorised by an internal motor assembly of the toy, such that the movement of adjacent disc elements with respect to one another is controllable. The disc elements each rotate about the central axis, and the ability to individually rotate the protrusions on their circumferences at different rates and in different directions allows for unique stimulation patterns.

Thus, according to one aspect of the present disclosure there is provided a sex toy apparatus, comprising: a handle portion; a power source disposed within the handle portion; a motor assembly coupled to the power source; a control interface coupled to the motor assembly; a tip portion; and a straight shaft between the handle portion and the tip portion, the shaft having a plurality of disc elements disposed along its length to form an exterior wall of the shaft, each disc element having a plurality of protrusions spaced about its circumference and being configured to rotate about the central axis of the shaft.

The motor assembly is configured, in response to an actuation of the control interface, to individually drive each of the dis elements of the shaft to rotate clockwise or anticlockwise about the central axis of the shaft.

In some embodiments, the motor assembly is configured to rotate the disc elements back and forth in tandem with one another, each disc element being offset from the movement of adjacent disc elements by a time delay to cause a swirling motion.

In some embodiments, the motor assembly is configured to rotate the disc elements in full rotations about the shaft central axis, with each disc element being moved in an opposing rotation to any adjacent disc elements.

In some embodiments, the control interface is configured to switch the motor assembly to different disc rotation patterns.

In some embodiments, the control interface is configured to switch the motor assembly to rotate the discs at different speeds.

In some embodiments, the apparatus further comprises a removeable lubricant chamber disposed within the handle portion, and further comprises a lubricant channel running from the lubricant chamber to an opening in the tip portion. The control interface may further be configured to cause the motor assembly to push lubricant from the removeable chamber out of the opening of the tip portion. The handle portion may also comprise a removable threaded cap and a hollow chamber for holding the lubricant chamber.

In some embodiments, the apparatus further comprises a magnetic charging port.

In some embodiments, the apparatus further comprises one or more LED indicators for indicating different charging modes.

### BRIEF DESCRIPTION OF THE DRAWINGS

Various embodiments of the invention are disclosed in the following detailed description and accompanying drawings.

FIG. 1 illustrates an isometric view of an example configuration of a sex toy apparatus according to the present disclosure in a static state.

FIG. 2 illustrates an isometric view of the example configuration of the sex toy apparatus in a first movement pattern.

FIG. 3 illustrates an isometric view of a handle portion of the example configuration with a removable cap and lubricant chamber removed.

FIG. 4 illustrates an isometric cutaway view of the example configuration with the placement of the internal lubricant chamber and channel shown.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a novel design for a sex toy apparatus with individually motorized disc elements forming a shaft wall. Each disc element has a set of protrusions about its circumference and is rotated about a central axis of the shaft by an internal motor assembly. Since the stacked disc elements are separately controllable, they can be moved in a large number of novel stimulation patterns, such as having adjacent discs perform offset oscillations, or having adjacent discs rotate in opposite directions. Such pre-set movement patterns can be selected via a control interface on a handle portion of the toy.

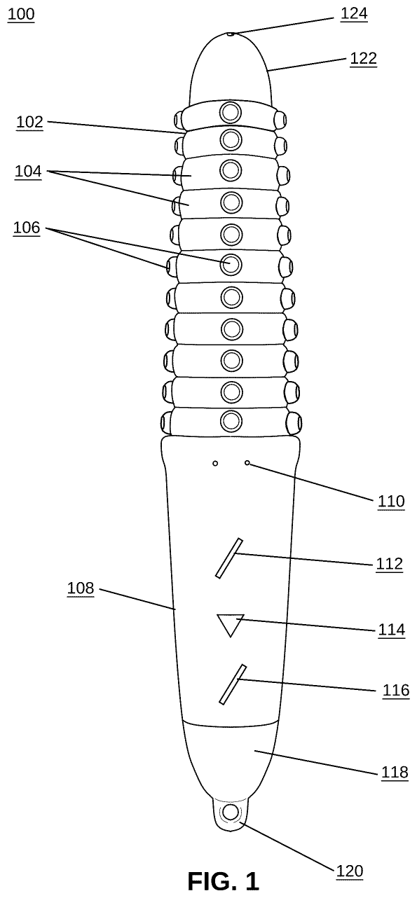

Referring to FIG. 1, an isometric view of an example configuration of a sex toy 100 is shown in a static state.

As can be seen, the toy 100 is formed of a tip portion 122, a shaft portion 102, and a handle portion 108, and is generally straight and round in shape, with a central axis running along its length.

The shaft portion 102 is formed of a plurality of stacked disc elements 104, each having a number of protrusions 106 disposed about their circumference. In FIG. 1 these are shown in a static state, with the device being turned off, and are thus in a rest state and aligned with each other.

The apparatus 100 has a rechargeable power source such as a I; and a charging port, which may be magnetic, for charging the apparatus. It also has a pair of LED indicators 110 that may flash to indicate power level and charging state information to a user.

The power source powers an internal motor assembly of the toy which is configured to rotate each of the disc elements 104 about the central shaft axis individually, allowing for unique stimulation patterns to achieved by varied movement of the knobbed protrusions 106.

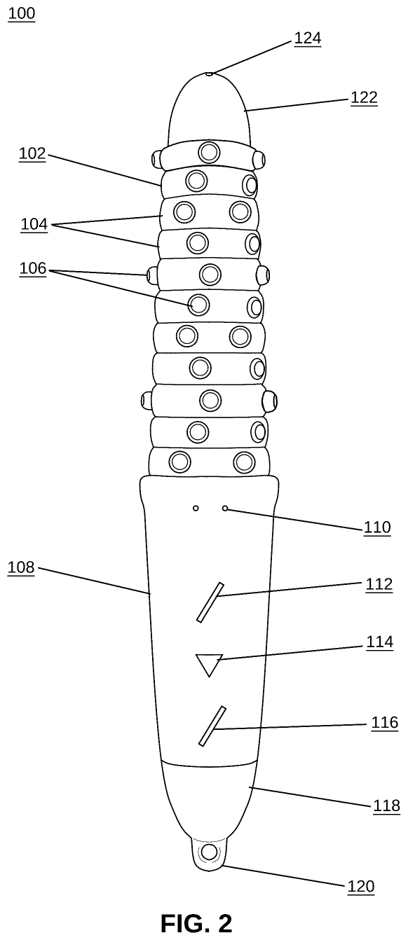

A set of control interface buttons 112, 114, and 116 may be used to power the apparatus on and switch between different movement patterns. For example, button 112 may caused the device to enter a first movement pattern where each disc element 104 is oscillated back and forth about the shaft axis in tandem with but slightly offset from each adjacent disc element as shown in FIG. 2, causing a “swirling” motion along the shaft for improved stimulation. Further actuations of button 112 may cause the same pattern to be implemented at different speeds.

Similarly, button 116 may be used to initiate a movement pattern where each disc element performs full continuous rotations about the central shaft axis in an opposite direction to any adjacent disc elements. Button 114 may be a power on/off button, or may be a lubricant button as described below.

This is merely one example configuration of the control interface, many other varied configurations are envisaged.

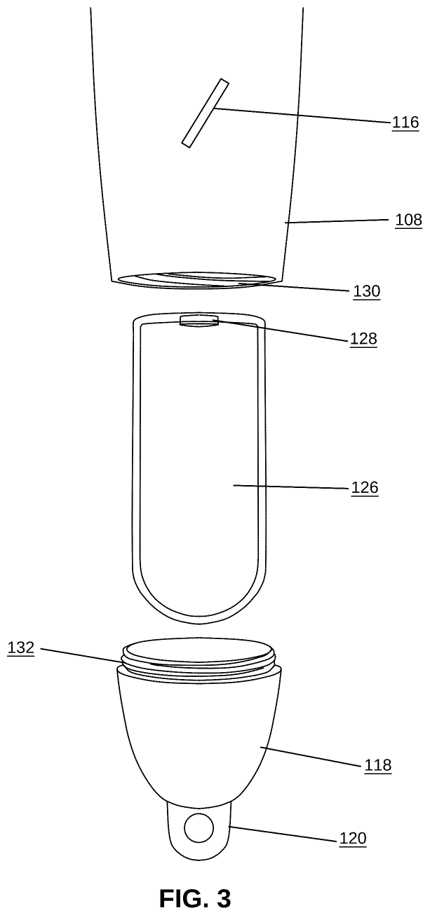

The apparatus 100 of the present example also has a removable screw cap 118 on the end of the handle portion 108. The cap 118 can be removed to reveal a chamber inside into which a lubricant cartridge can be placed, as shown in FIG. 3. As will be described below, this facilitates the channelling of lubricant through the shaft and out of opening 124 in the tip portion.

The end of the cap 118 is fitted with a ring 120 for looping a decorative chain or the like through.

Referring to FIG. 3, an isometric view of the handle portion 108 of the example configuration is show with the screw cap 118 and lubricant chamber 126 removed.

As can be seen, the lubricant chamber/cartridge 126 is shaped to fit entirely within the hollow space formed by the handle portion, and the threaded portions of the handle end 132 and handle body 130 allow the cartridge 126 to be lock securely in place.

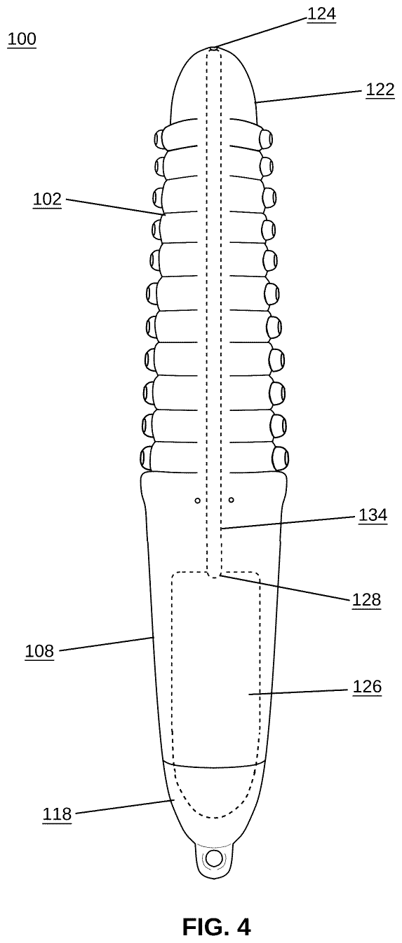

When installed within the handle portion 108 of the toy 100, an opening 128 of the lubricant cartridge 126 comes into contact with a lubricant channel of the toy 100 which runs through the centre of the shaft to the opening 124 in the tip, as shown in FIG. 4.

This arrangement allows the automated application of lubricant to the tip of the toy, which may be assisted by the internal motor assembly of the toy 100 by, for example, pressing button 114 while the toy is in use.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the sex toy apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A sex toy apparatus, comprising:
a handle portion;
a power source disposed within the handle portion;
a motor assembly coupled to the power source;
a control interface coupled to the motor assembly;
a tip portion; and
a straight shaft between the handle portion and the tip portion, the shaft having a plurality of disc elements disposed along its length to form an exterior wall of the shaft, each disc element having a plurality of protrusions spaced about its circumference and being configured to rotate about the central axis of the shaft;
wherein the motor assembly is configured, in response to an actuation of the control interface, to individually drive each of the disc elements of the shaft to rotate clockwise or anticlockwise about the central axis of the shaft.

2. A sex toy apparatus according to claim 1, wherein the motor assembly is configured to rotate the disc elements back and forth in tandem with one another, each disc element being offset from the movement of adjacent disc elements by a time delay to cause a swirling motion.

3. A sex toy apparatus according to claim 1, wherein the motor assembly is configured to rotate the disc elements in full rotations about the shaft central axis, with each disc element being moved in an opposing rotation to any adjacent disc elements.

4. A sex toy apparatus according to claim 1, wherein the control interface is configured to switch the motor assembly to different disc rotation patterns.

5. A sex toy apparatus according to claim 1, wherein the control interface is configured to switch the motor assembly to rotate the discs at different speeds.

6. A sex toy apparatus according to claim 1, wherein the apparatus further comprises a removeable lubricant chamber disposed within the handle portion, and further comprises a lubricant channel running from the lubricant chamber to an opening in the tip portion.

7. A sex toy apparatus according to claim 6, wherein the control interface is configured to cause the motor assembly to push lubricant from the removeable chamber out of the opening of the tip portion.

8. A sex toy apparatus according to claim 6, wherein the handle portion comprises a removable threaded cap and a hollow chamber for holding the lubricant chamber.

9. A sex toy apparatus according to claim 1, wherein the apparatus further comprises a magnetic charging port.

10. A sex toy apparatus according to claim 1, wherein the apparatus further comprises one or more LED indicators for indicating different charging modes.
